(19) United States
(12) Patent Application Publication
(10) Pub. No.: US 2010/0296299 A1
(43) Pub. Date: Nov. 25, 2010

(54) Demountable Lampshade

(76) Inventor: Ching-Hui CHEN, Huzihou City (CN)

Correspondence Address: Jackson Intellectual Property Group PLLC, 106 Starvale Lane, Shipman, VA, 22971, US

(21) Appl. No.: 12/779,113

(22) Filed: May 13, 2010

(30) Foreign Application Priority Data
May 22, 2009 (CN) 200920057186.9

(51) Int. Cl. F21V 11/00

(52) U.S. Cl. 362/351

(57) ABSTRACT

The present invention provides a demountable lampshade that comprises a frame and a semitransparent mask; the frame includes a support ring, a fixing plate, and support bars connecting the support ring and the fixing plate; a lamp installation seat is arranged on the fixing plate; the mask is formed by multiple non-light tight surfaces being connected, is provided with up and down two openings, and is demountable to be arranged to the frame by socket joint. The mask not only can be mounted to the frame to form a lampshade, but also can be folded up to be stored solely without the frame, thereby being more convenient for dismounting and transport. The mask and the frame are independent to each other, so, if either one is damaged, it can be directly replaced without the need to discard the whole lampshade.

### FIELD OF THE INVENTION

The present invention involves the technical field of lighting equipments, particularly involves a demountable lampshade.

### BACKGROUND OF THE INVENTION

Most of conventional lampshades are composed of a frame and a mask. The frame mostly adopts metal, wood, plastic, or other materials. The mask mostly adopts transparent materials, such as glass, or plastic. Also some masks are made of semitransparent materials like cloth. The lampshades adopting a cloth mask can make the light emitted by the lamp to be soft, which have a hazy aesthetic feeling, so they are popular. The mask and frame of this kind of lampshade mostly are fixedly connected as one body to be not demountable, so, this kind of lampshade has a comparatively big occupation space and high transportation cost. When any of the mask and the frame is damaged, the whole lampshade has to be discarded as useless, thereby causing a great waste and being bad for environmental protection.

### SUMMARY OF THE INVENTION

The object of the present invention is aiming at the disadvantages of the conventional art to provide a lampshade with demountable mask and frame.

The technical solution of the present invention to solve the technical problem is that: a demountable lampshade comprises a frame and a semitransparent mask; the frame includes a support ring, a fixing plate, and support bars connecting the support ring and the fixing plate; a lamp installation seat is arranged on the fixing plate; the mask is formed by multiple non-light tight surfaces being connected, is provided with up and down two openings, and is demountable to be arranged to the frame by socket joint.

The mask is a whole piece of non-light tight material bended for multiple times, and the beginning portion and end portion of the material are bonded with Velcro.

The mask can also be a whole structure by fixedly bonding the beginning portion and end portion.

The support ring is a rectangular structure formed by connecting four rods end to end, and the support bars are respectively arranged at each corner of the support ring.

The fixing plate is provided with light holes that are evenly arranged around the lamp installation seat. The fixing plate is provided with locating pillars between the light holes and the support bars.

The advantages of the present invention are that: the mask is formed by multiple non-light tight surfaces being connected, is provided with up and down two openings, and is demountable to be arranged to the frame by socket joint. So, the mask not only can be mounted to the frame to form a lampshade, but also can be folded up to be stored solely without the frame, thereby being more convenient for dismounting and transport. The mask and the frame are independent to each other, so, if either one is damaged, it can be directly replaced without the need to discard the whole lampshade.

### BRIEF DESCRIPTION OF THE DRAWINGS

Aspects of the present invention are best understood from the following detailed description and the accompanying figures.

FIG. 1 is a structure schematic diagram of the present invention;

FIG. 2 is a stereo exploded schematic diagram of the present invention.

### DESCRIPTION OF THE PREFERRED EMBODIMENT

Hereinafter, the present invention is described detailedly with reference to the accompanying figures.

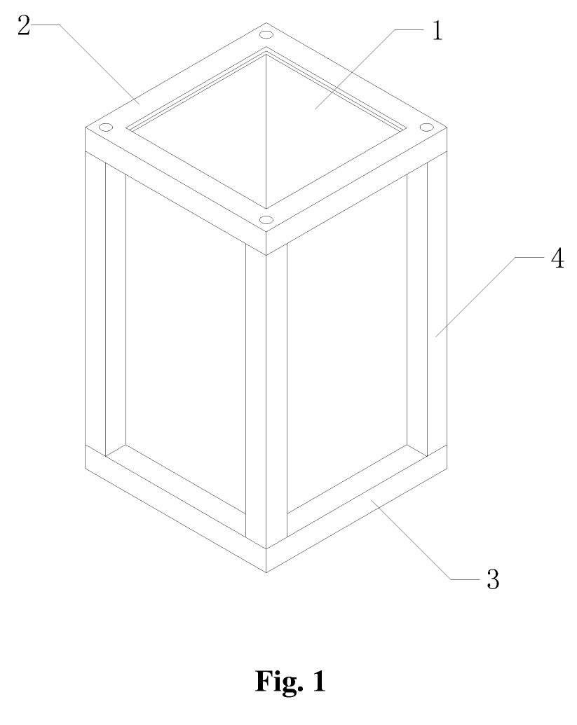

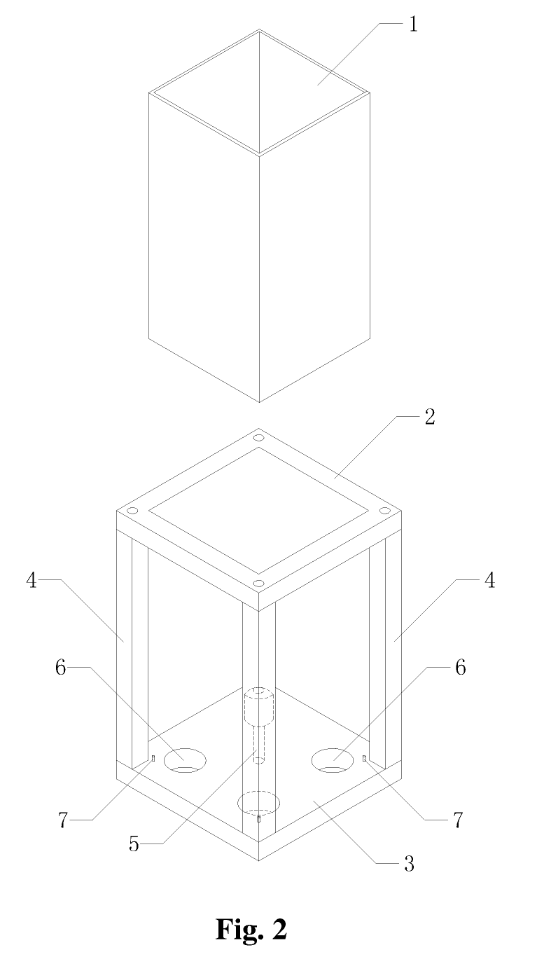

As shown in FIG. 1 and FIG. 2, a demountable lampshade comprises a frame and a semitransparent mask 1; the frame includes a support ring 2, a fixing plate 3, and support bars 4 connecting the support ring 2 and the fixing plate 3; a lamp installation seat 5 is arranged on the fixing plate 3; the mask 1 is formed by multiple non-light tight surfaces being connected and is provided with up and down two openings, which is demountable to be arranged at the inner face or outer face of the frame. The mask 1 of the present invention not only can be mounted to the frame to form a lampshade, but also can be folded up to be stored solely without the frame, thereby being more convenient for dismounting and transport. The mask 1 and the frame are independent to each other, so, if either one is damaged, it can be directly replaced without the need to discard the whole lampshade.

As a preferred embodiment, the mask 1 is a whole piece of non-light tight material bended for multiple times, and the beginning portion and end portion of the material are bonded with Velcro, so, the mask 1 can be put away by the way of being unfolded as one piece. Furthermore, the mask 1 can also be a whole structure by fixedly bonding the beginning portion and end portion, so that the mask 1 can also be put away by the way of being doubled.

The support ring 2 is a rectangular structure formed by connecting four rods end to end, and the support bars 4 are respectively arranged at each corner of the support ring 2. The fixing plate 3 is provided with light holes 6 that are evenly arranged around the lamp installation seat 5, so that the light emitted by the lamp can also pass through the light holes 6 to increase the aesthetic property of the lampshade. The fixing plate 3 is provided with locating pillars 7 between the light holes 6 and the support bars 4. The locating pillars 7 can locate the mask 1 to increase the practicability.

Although the present invention has been described in detail with the above embodiments, it is not to limit the scope of the invention. It is to be understood that all the modifications and changes according to the characteristic and spirit of the present invention are involved in the protected scope of the present invention.

What is claimed is:

1. A demountable lampshade comprising a frame and a semitransparent mask; the frame including a support ring, a fixing plate, and support bars connecting the support ring and the fixing plate; a lamp installation seat being arranged on the fixing plate; the mask being formed by multiple non-light tight surfaces being connected, being provided with up and down two openings, and being demountable to be arranged to the frame by socket joint.

2. The demountable lampshade of claim 1, wherein the support ring is a rectangular structure formed by connecting four rods end to end, and the support bars are respectively arranged at each corner of the support ring.

3. The demountable lampshade of claim 2, wherein the fixing plate is provided with light holes that are evenly arranged around the lamp installation seat.

4. The demountable lampshade of claim 3, wherein the fixing plate is provided with locating pillars between the light holes and the support bars.

5. The demountable lampshade of claim 1, wherein the mask is a whole piece of non-light tight material bended for multiple times, and the beginning portion and end portion of the material are bonded with Velcro.

6. The demountable lampshade of claim 5, wherein the support ring is a rectangular structure formed by connecting four rods end to end, and the support bars are respectively arranged at each corner of the support ring.

7. The demountable lampshade of claim 6, wherein the fixing plate is provided with light holes that are evenly arranged around the lamp installation seat.

8. The demountable lampshade of claim 7, wherein the fixing plate is provided with locating pillars between the light holes and the support bars.

9. The demountable lampshade of claim 1, wherein the mask can also be a whole structure by fixedly bonding the beginning portion and end portion.

10. The demountable lampshade of claim 9, wherein the support ring is a rectangular structure formed by connecting four rods end to end, and the support bars are respectively arranged at each corner of the support ring.

11. The demountable lampshade of claim 10, wherein the fixing plate is provided with light holes that are evenly arranged around the lamp installation seat.

12. The demountable lampshade of claim 11, wherein the fixing plate is provided with locating pillars between the light holes and the support bars.
